(19) United States
(12) Patent Application Publication
(10) Pub. No.: US 2008/0238860 A1
(43) Pub. Date: Oct. 2, 2008

(54) LIQUID CRYSTAL DISPLAY APPARATUS

(75) Inventor: Yoshinori ONODERA, Tokyo (JP)

Correspondence Address: Studebaker & Brackett PC, 1890 Preston White Drive, Suite 105, Reston, VA, 20191, US

(73) Assignee: OKI ELECTRIC INDUSTRY CO., LTD., Tokyo (JP)

(21) Appl. No.: 12/043,191

(22) Filed: Mar. 6, 2008

(30) Foreign Application Priority Data
Mar. 29, 2007 (JP) 2007-087498

(51) Int. Cl. G02F 1/13357

(52) U.S. Cl. 345/102

(57) ABSTRACT

A display apparatus having an LCD panel and an LED backlight panel performs display, which includes a display area brightness calculation section which calculates brightness of each of a plurality of display areas based on the image data; a brightness sensor provided in each of a plurality of backlight areas to detect emitted light brightness of the plurality of backlight areas; a controller for adjusting the brightness of each of the backlight areas, based on the display area brightness and the emitted light brightness in each of the backlight areas; and an LED driver for driving each of the LEDs of the backlight panel.

### BACKGROUND OF THE INVENTION

1. Field of the Invention

The present invention relates to a liquid crystal display, and more particularly, to a liquid crystal display apparatus having a backlight panel using light-emitting diodes.

2. Description of the Related Art

The liquid crystal displays (LCD) are extremely widely used as a monitor display of the PC (personal computers), and a display device of the information terminal devices such as PDA (personal digital assistant). Moreover, LCD has recently been widely used for a display having a large screen of more than 30 inches, and researches and development on the more advanced liquid crystal displays are actively promoted.

In such crystal liquid displays, white light emitting diodes (LEDs) are sometimes used as a light source of the liquid crystal panel back face. Among the light-emitting diodes, there are one which emits white color by lighting the red, green and blue LEDs simultaneously to emit white color, and another one which emits white color by additive mixture of blue or blue-violet LED and yellow fluorescent material or the like. Such backlight light source had a problem of being poor in color rendering properties or capabilities due to variation in color, and the like. See, for example, refer to Japanese Unexamined Patent Publication Kokai No. 2002-231032 (hereinafter, also referred to as a Patent Document 1).

As mentioned above, in accordance with enlargement of applications to the large screen display (TV)and the like, in the backlight panel using a light-emitting diode also, strongly sought after are increased performance of the liquid crystal displays strongly sought after, such as uniformity of brightness, improvement of color rendering property or capability, and enlargement of chromaticity.

However, there has been a problem that the brightness and color rendering property over the entire surface of the panel become deteriorated due to individual difference in lighting property of the LED elements, non-uniformity of temperature during operation, or characteristics changes over time of the LED elements.

### SUMMARY OF THE INVENTION

The present invention has been made in view of the points described above, and it is an object of the invention to provide a high-performance liquid crystal display apparatus having uniformity in brightness and color rendering property over the entire surface of the display panel.

A liquid crystal display apparatus according to the present invention is a liquid crystal display apparatus which includes a liquid crystal display panel and a backlight panel having LEDs (light emitting diodes) lighting the liquid crystal panel from the back face thereof, and performs display based on image data, the liquid crystal display apparatus comprises a display area brightness calculation section which divides the liquid crystal panel into a plurality of display areas, and calculates a display area brightness for each of the plurality of display areas, based on the image data; an emitted light brightness sensor which is provided in each of a plurality of backlight areas set in the backlight panel, and detects emitted light brightness for each of the backlight areas; a light adjustment controller for adjusting the brightness of each of the backlight areas, based on the display area brightness and the emitted light brightness in each of the backlight areas; and an LED driver for driving each of the LEDs of the backlight panel.

### BRIEF DESCRIPTION OF THE DRAWINGS

FIG. 1 is a block diagram schematically showing the configuration of a liquid crystal display apparatus according to an embodiment of the present invention;

FIG. 2 is a diagram schematically showing the detailed configuration of a liquid crystal panel, where switching elements (TFT) are provided at the intersections of scanning lines (SL) and the data lines (DL);

FIG. 3 is a diagram schematically showing the detailed configuration of a crystal liquid display (LCD) apparatus, in particular, a backlight panel according to the embodiment;

FIG. 4 is a diagram schematically showing the detailed configuration of a backlight panel, where RGB-LEDs, a temperature sensor, and a light sensor are provided in the backlight section.

### DETAILED DESCRIPTION OF THE INVENTION

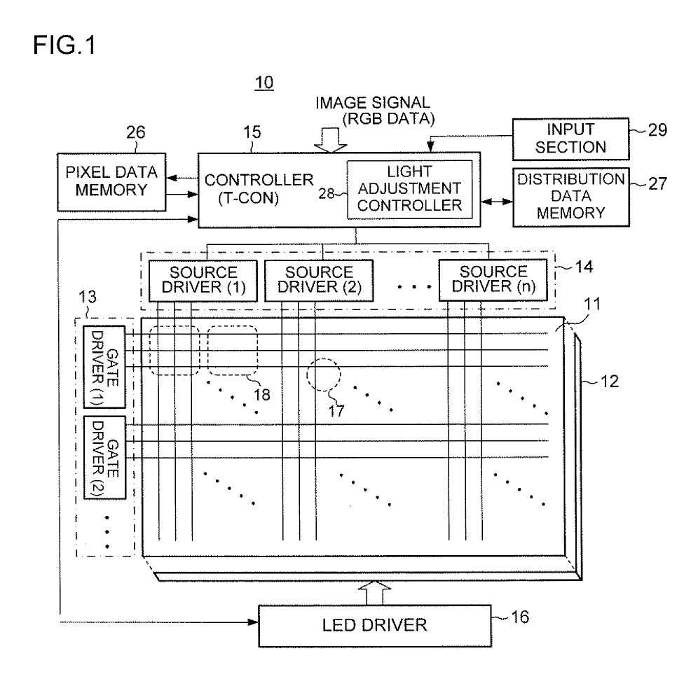

In the following, preferred embodiments of the present invention will be described in detail with reference to the drawings. FIG. 1 is a block diagram schematically showing the configuration of a liquid crystal display apparatus 10 according to an embodiment of the present invention. The display section of the liquid crystal display (LCD) apparatus 10 is comprised of a liquid crystal (LCD) panel 11, and a backlight panel (or backlight module) 12. Further, the liquid crystal panel (LCD) apparatus 10 is provided with a gate driver 13 and a source driver 14 for driving the liquid crystal (LCD) panel 11, and the gate driver 13 and the source driver 14 are controlled by a controller 15.

Further, the liquid crystal display (LCD) apparatus 10 is provided with a backlight driver (LED driver) 16 for driving the backlight panel 12. The backlight driver 16 is controlled by the controller 15. In the liquid crystal (LCD) panel 11, a liquid crystal material is held between two sheets of transparent plates such as glass plates opposed to each other. Specifically, adjustment of voltage applied to the liquid crystal changes light transmission from the backlight panel 12, and thereby changes the brightness to perform display.

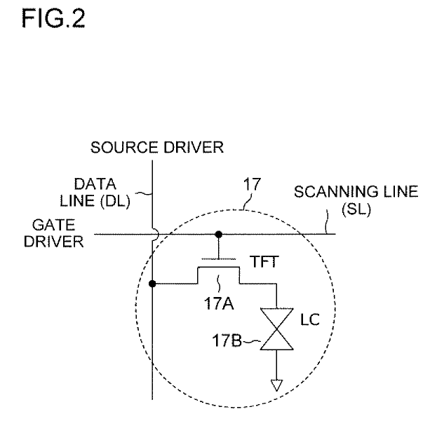

In the liquid crystal (LCD) panel 11, provided are a plurality of scanning lines, and a plurality of data lines arrayed in a direction intersecting with the scanning lines (for example, in the orthogonal direction). Further, as shown in FIG. 2, a thin film transistor (TFT) 17A is provided at the intersecting position of the scanning lines (SL) and the data lines (DL). For example, scanning lines (SL) are connected the gates of the TFT 17A, and the data lines are connected to the source of TFT 17A. And, configuration is made so that the transmission of the liquid crystal section (LC) 17B is controlled in accordance with a data signal supplied from the data line corresponding to scanning of the scanning line, thereby performing two-dimensional display.

Thus, a display element 17 is comprised of a thin film transistor (TFT) 17A and the liquid crystal (LC) section 17B. The display element 17 is arrayed in a form of matrix to form the liquid crystal (LCD) panel 11.

Specifically, when a liquid crystal display (LCD) apparatus 10 is a color liquid crystal display apparatus, one picture element is comprised of three display elements 17 of red, green and blue (DGB), and color representation is performed by passing the transmission light through red, green and blue (RGB) filters.

The configuration of the liquid crystal display (LCD) apparatus 10 will be described in detail with reference to FIG. 1. The scanning lines of the liquid crystal display (LCD) panel 11 are connected with the gate driver 13, and the data lines are connected with the source driver 14. In this event, as shown in FIG. 1, the gate driver 13 may be comprised of one or more gate driver ICs (LSIs), i.e., may be comprised of a gate driver IC (1), a gate driver IC (2) . . . a gate driver IC (m) (hereinafter, these gate driver ICs are collectively called “gate driver”). Further, the source driver 14 may be comprised of one or more source driver ICs (LSI), i.e., may be comprised of a source driver IC (1), a source driver IC (2) . . . a source driver IC (n) (hereinafter, these source driver ICs are generically called “source driver”) (where, “m” and “n” are a natural number).

An image signal (for example, RGB signals) input to the liquid crystal display (LCD) apparatus 10 is supplied to the controller 15. The controller 15 has control capability as so-called “timing controller (T-CON).”

In the display operation of the liquid crystal display (LCD) apparatus 10, the gate driver 13 performs line sequential scanning by sequentially supplying to the scanning lines a scanning voltage signal (scan pulse) which scans the scanning lines at a specified scanning timing.

The source driver 14 receives a data signal (data signal such as gradation data and color data) supplied from the controller 15. The source driver 14 supplies to each of the data lines the voltage applied to the liquid crystal, in correspondence with the data signal. In this event, the voltage applied to the data lines is supplied in accordance with the scanning timing by the gate driver 13.

For example, the source driver 14 receives digital data (for example, 8 bits) as color data from the controller 15. The source driver 141 for example, converts the color data signal into an analog voltage signal corresponding to the gamma characteristic representing the relation between applied voltage and transmission of a liquid crystal material. That is, the source driver 14 may have a digital-analog conversion circuit (DAC). The analog voltage generated by the DAC is output to the panel.

The applied voltage signal described above is applied to the liquid crystal section (LC) 17B of each pixel through TFT 17A. That is, the applied voltage signal is written to each of pixels, and is displayed in correspondence with the applied voltage, and such display state is held by the capacitance of the liquid crystal in itself until next writing.

### [Configuration Concerning Lighting Control]

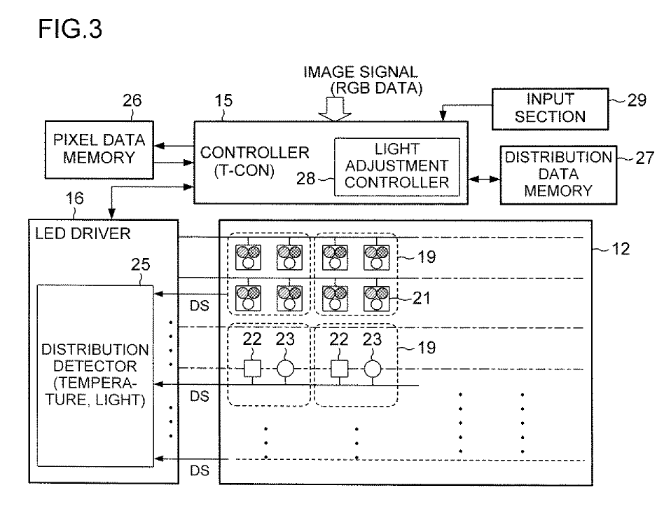

The configuration and operation concerning light adjustment control will now be described in more detail. Referring to FIG. 3, in the backlight panel 12, provided is a plurality of white LED elements 21 each comprised of three colors of red, green and blue (RGB) LED (hereinafter called “RGB-LED”). The plurality of RGB-LEDs 21 is connected with the LED driver 16, and are driven by the LED driver 16. The LED driver 16 is connected bi-directionally with the controller 15, and is operated by control of the controller 15.

In this event, the LED driver 16 may be comprised of one or more driver IC's (LSI's). Below, these driver ICs comprising LED driver are generically called the LED driver 16.

The backlight panel 12 is divided into a plurality of lighting areas 19 (also called “backlight sectional area” or simply “backlight section”), and each of the backlight sections 19 comprises at least one RGB-LED 21. And, each of the backlight sections 19 is provided with a temperature sensor 22 and a light sensor 23, respectively.

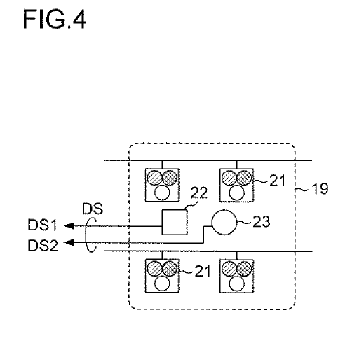

In more detail, as shown in FIG. 3 and FIG. 4, the backlight section 19 is provided with a temperature sensor 22 and a light sensor 23, in addition to four RGB-LEDs 21. The temperature sensor 22 and light sensor 23 detect the temperature and light intensity respectively at the areas 19, and supply a detection signal DS (a temperature detection signal DS1, a light intensity detection signal DS2) to a distribution detector 25 provided in LED driver 16.

In this event, each of the backlight sections 19 is not meant to be physically divided, but is meant to be divided (set) as a measured area to detect temperature and light intensity.

Further, FIG. 3 and FIG. 4 show a case where each of the backlight sections 19 comprises four RGB-LEDs 21, but they are shown as an example. Further, the number of RGB-LEDs 21 comprised in each of the backlight sections may be different. In short, such configuration may be admitted when temperature distribution and light intensity in the backlight panel 12 are adequately obtained. In this event, the backlight section 19 may be divided in such a way as to correspond to an area comprised of a plurality of pixels (display section) 18, later described. Or, the backlight section 19 may be divided independently of the display section 18.

The distribution detector 25 receives a temperature detection signal DS1 and light intensity detection signal DS2, respectively from each of the temperature sensors 22 and each of the light sensors 23, which are provided in the backlight panel 12, and calculates the temperature distribution and the light intensity distribution in the backlight panel 12. In more detail, the distribution detector 25 measures the temperature and the light intensity in each of the backlight sections 19, and calculates the temperature distribution and the light intensity distribution (dispersion information) in the backlight panel 12 based on the measured values. The RGB-LED 21 varies in emitted light brightness with temperature change and with time. Further, there is an individual difference due to variation in manufacture of the LED elements. For example, there is a variation of about 10% in terms of driving voltage.

Therefore, the temperature sensor 22 and the light sensor 22 serve as an emitted light sensor provided in the backlight section 19.

The temperature distribution and/or the light intensity distribution (dispersion information) of the backlight panel 12 calculated by the distribution detector 25 are made into digital data, and are supplied to the controller 15. For example, according to such measured temperature distribution and/or measured light intensity distribution, they are calculated as brightness distribution data (distribution data of backlight emitted light brightness) and are made into digital data. The distribution data of the backlight brightness is stored in a distribution data memory 27 by control of the controller 15. The distribution data memory 27 is comprised of nonvolatile memories.

### [Light Adjustment Control Operation]

The controller 15 receives RGB pixel data which is an image signal. Further, the controller 15 temporarily stores in the pixel data memory 26, image data equivalent to one frame, based on the received image signal. The controller 15 calculates the brightness of the frame (screen) based on such stored data equivalent to one frame.

The controller 15 sends the calculated distribution data to the LED driver 16, and adjusts the brightness of the entire screen or desired part of the screen area.

In more detail, for example, as shown in FIG. 1, the screen area (display area) of the liquid crystal (LCD) panel 11 is divided into a plurality of areas 18 (also called “display sectional area” or simply “display section”).

In this event, each of the display sections 18 is not meant to be physically divided, but is meant to be divided (set) as a calculated area to calculate the brightness by image data.

The controller 15 is provided with a light adjustment control section 28 which has computation processing capability for RGB-LED light adjustment control of the backlight panel 12. Based on data stored (primary retention) in the pixel data memory 26, the controller 15 performs computation processing for the entire screen or any screen display area (display section). By this processing, the brightness of the entire screen or each of any display sections is calculated. Information on each of the RGB-LEDs 21 stored in the nonvolatile memory is used as a parameter for the computation processing, and is sent to the LED driver 16 for optimum brightness adjustment.

The light adjustment control section 28 serves as a display area brightness calculation section for calculating the brightness of the display area (display section). The controller 15 and the light adjustment control section 28 jointly perform light adjustment control, later described.

The light adjustment control section 28 sends the calculated brightness data to the LED driver 16, and performs brightness adjustment of the display sections and the entire display. The red LED element (R), the green LED element (G) and the blue LED element (B) of the RGB-LED 21 are respectively submitted to individual luminance graduation control. For example, gradation control in 8-bit gradation (256 steps) is performed. By such control, variation of the brightness and emitted light color of the RGB-LEDs 21 can be restricted.

Therefore, by such control, the brightness or luminance control and variation of the emitted light color on the display screen can be adjusted in correspondence to change of the image data, i.e., dynamic change of the image brightness.

The computation processing and brightness adjustment described above, by the controller 15 (and the light adjustment control section 28) may be performed for each frame of image data, or may be performed by a specified number of frames. On the other hand, the light adjustment control section 28 may be configured so as to calculate the brightness change between frames, and to perform brightness adjustment in accordance with the brightness change. In this event, configuration can be made so that pixel data corresponding to several frames is stored in the pixel data memory 26.

Further, as described above, the brightness distribution data of the backlight panel 12 which is stored in the distribution data memory 27 such as nonvolatile memory or the nonvolatile memory-built-in the LED driver 16 is read by the light adjustment control section 28, and is used as a computation processing parameter in the lighting control section 28. Then, the computed data is supplied to the LED driver 16; the LED driver 16 is controlled according to the computed data; and each of the backlight sections 19 is adjusted to an optimum brightness. Specifically, as described above, each of the backlight sections 19 is configured so as to include one or more of the RGB-LEDs 21. For example, configuration can be made so that a temperature sensor 22 and/or a light sensor 23 are provided for each of the RGB-LEDs 21 so as to permit the control to each of the RGB-LEDs.

In this event, the light adjustment control is performed by the measured values of the temperature sensor 22 and the light sensor 23, or by distribution of the measured values. Further, the light adjustment control by the measured values or the distribution of measured values is performed independently of the pixel data.

Specifically, the LED driver 16 for driving The LED 21 has a nonvolatile memory, and in the nonvolatile memory, stored as data are the measured values of the temperature sensor and the light sensor, as well as year-by-year information or information on variation over time of the measured information. The light adjustment control section 28 may be configured in such a manner as to perform brightness adjustment based on the year-by-year information or the information on variation over time.

In this event, the calculation and/or collection of the brightness distribution (temperature and light intensity distribution) data of the backlight section 19 can be configured at desired time or at a desired interval of time based on user input to an input section 29, under the control of the controller 15. On the other hand, in response to the user input to the input section 29, for example, the execution can be configured in response to input made by depressing a command switch which commands distribution data collection, and the like.

As explained in detail in the embodiment, for both dynamic change of image brightness and variation (brightness distribution) of each the LED of the backlight, an optimum adjustment can be made, and uniform adjustment with good color rendering property can be made, while restricting variation of the emitted light color, and the like.

Further, as the brightness distribution information of the backlight LED is retained in the nonvolatile memory, an optimum brightness control can be made immediately after rising at the power-on time of the liquid crystal display (LCD) apparatus.

Therefore, solved is the problem of the conventional art in that the brightness in the entire display panel and uniformity of color rendering property or capability deteriorate due to temperature non-uniformity during operation, change of the LED elements over time, and a high-quality and high-performance liquid crystal display can be provided.

The invention has been described with reference to the preferred embodiments thereof. It should be understood by those skilled in the art that a variety of alterations and modifications may be made from the embodiments described above. It is therefore contemplated that the appended claims encompass all such alterations and modifications.

This application is based on Japanese Patent Application No. 2007-087498 which is hereby incorporated by reference.

What is claimed is:

1. A liquid crystal display apparatus which includes a liquid crystal display panel and a backlight panel having LEDs (light emitting diodes) lighting the liquid crystal panel from the back face thereof, and performs display based on image data, the liquid crystal display apparatus comprising:
a display area brightness calculation section which divides the liquid crystal panel into a plurality of display areas, and calculates a display area brightness for each of the plurality of display areas, based on the image data;
an emitted light brightness sensor which is provided in each of a plurality of backlight areas set in the backlight panel, and detects emitted light brightness for each of the backlight areas;
a light adjustment controller for adjusting the brightness of each of the backlight areas, based on the display area brightness and the emitted light brightness in each of the backlight areas; and
an LED driver for driving each of the LEDs of the backlight panel.

2. A liquid crystal display apparatus according to claim 1, wherein the light adjustment controller calculates the display area brightness based on pixel data for each of the frames of the image data.

3. A liquid crystal display apparatus according to claim 1, wherein the backlight panel is comprised of a plurality of light sources, each one of which is comprised of red, green and blue (RGB) LEDs in the inside of the lighting face.

4. A liquid crystal display apparatus according to claim 1, wherein the emitted light sensor comprises a temperature sensor and a light sensor.

5. A liquid crystal display apparatus according to claim 1, wherein the LED driver for driving the LED has a nonvolatile memory, and stores the measured values of the temperature sensor and light sensor, and changes over time of the measured values.

6. A liquid crystal display apparatus according to claim 3, wherein the light adjustment controller performs individual luminance control of each of the red, green and blue (RGB) LEDs.

7. A liquid crystal display apparatus according to claim 3, wherein the light adjustment controller calculates a brightness change between frames to perform brightness adjustment in accordance with the brightness change.

8. A liquid crystal display apparatus according to claim 1, further comprising a distribution detector which calculates brightness distribution of the backlight panel on the basis of detected emitted light brightness for each of the backlight areas, wherein the light adjustment controller adjust the brightness of each of the backlight areas on the basis of the brightness distribution.

9. A liquid crystal display apparatus according to claim 5, further comprising a command input section to receive a command input, wherein the distribution detector performs calculation of the brightness distribution in response to the command input.

10. A liquid crystal display apparatus according to claim 5, wherein the light adjustment controller performs brightness control of each of the backlight areas based on the changes over time of the measured values.
